(19) United States
(12) Patent Application Publication
(10) Pub. No.: US 2009/0106305 A1
(43) Pub. Date: Apr. 23, 2009

(54) DOCUMENT PROCESS HISTORY MANAGING SYSTEM, DOCUMENT PROCESS HISTORY MANAGING APPARATUS, DOCUMENT PROCESS HISTORY MANAGING METHOD, AND COMPUTER READABLE MEDIUM

(75) Inventor: Tetsunori MURAKAMI, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/129,365

(22) Filed: May 29, 2008

(30) Foreign Application Priority Data
Oct. 19, 2007 (JP) 2007-271904

(51) Int. Cl. G06F 17/30

(52) U.S. Cl. 707/103 R; 707/E17.009

(57) ABSTRACT

A document process history managing system includes: a storage apparatus; and a document process history managing apparatus including: a process operation information accepting unit; a version information applying unit; a recording unit; and an operation history representing unit.

### CROSS-REFERENCE TO RELATED APPLICATIONS

This application is based on and claims priority under 35 U.S.C. 119 from Japanese Patent Application No. 2007-271904 filed Oct. 19, 2007.

### BACKGROUND

1. Technical Field

The present invention is related to a document process history managing system, a document process history managing apparatus, a document process history managing method, and a computer readable medium, capable of recording/saving/managing images of documents in combination with process histories thereof, while the images of the documents have been processed by an image processing apparatus equipped with a function (will be referred to as “image acquisition function”) for reading images formed on output media such as paper so as to acquire image data thereof, and another function (will be referred to as “image output function”) for outputting images on output media such as paper based upon image data for output purposes.

2. Related Art

In apparatuses (typically known as “scanners”) equipped with image acquisition functions capable of reading images so as to acquire electronic data thereof, apparatuses (known as “copying apparatuses” and digital “multi-function machines”) equipped with functions capable of duplicating images, and also image processing apparatuses (will also be referred to as “imaging appliances”) such as printing apparatuses for outputting images on paper media and the like, systematic ideas called as “image log managing” systems have been proposed. That is, in these imaging log managing systems, processed images of documents are recorded/saved/managed in combination with conditions when these document images were processed as process histories (will also be referred to as “logs”). As a result, processing day/time and process instructing persons with respect to a specific document image can be traced.

The above-described image log managing systems (will be typically referred as “document process history management” hereinafter) may be utilized in countermeasures for information leakage, securing of enterprise compliance, internal controls of enterprises, and the like. For instance, an organization which has conducted the above-described document history managing system can grasp later such a process history, namely, “when” relevant document images were processed by “who” by employing an image processing apparatus (will also be referred to as “imaging appliance” hereinafter) equipped with an image acquisition function and an image output function, and “what information” was processed by the image processing apparatus. As a result, the organization can suppress leakage of information, can investigate problems occurred after the information leakage, and can certificate judging materials utilized when the organization made judgements.

As basic systematic ideas capable of recording, saving, and managing process histories of document images, it is required to record conditions when various operations were carried out with respect to these documents, and therefore, various sorts of methods for recording these conditions have been proposed.

### SUMMARY

According to an aspect of the present invention, a document process history managing system includes: a storage apparatus that stores information; and a document process history managing apparatus that is operated in such a manner that, in a case where a process operation is carried out on a document by employing an image processing apparatus, historical information of the process operation is saved in the storage apparatus in combination with the image of the document, the document process history managing apparatus including: a process operation information accepting unit that accepts information about the process operation with respect to a document to be processed; a version information applying unit that applies version information indicating derivative relationship based upon a document before the process operation is carried out in correspondence with the document to be processed, every time the process operation is carried out, based upon the information of the process operation accepted by the process operation information accepting unit regardless of such a fact as to whether or not an editing operation is performed, and whether or not a copying operation is performed with respect to the document; a recording unit that stores an image indicating a document which includes a processed result obtained based upon the document to be processed, the information about the operation history, and the version information applied by the version information applying unit into the storage apparatus in correspondence with each other; and an operation history representing unit that produces information about operation histories of respective documents having a derivative relationship with the document to be retrieved in a condition that a retrieving instruction is accepted, and represents the produced operation history information.

### BRIEF DESCRIPTION OF THE DRAWINGS

Exemplary embodiment of the present invention will be described in detail based on the following figures, wherein:

FIG. 1 is a diagram for indicating one structural example of a document process history managing system to which an embodiment mode of the present invention has been applied;

FIG. 2 is a diagram for indicating a structural example as to a document process history managing apparatus;

FIG. 3 is a diagram for explaining a summary of a major process operation executed in a version updating unit;

FIG. 4 is a diagram for representing derivative relationship among documents which are produced in a first comparison example with respect to the embodiment mode of the present invention;

FIG. 5 is a diagram as to a first example indicative of derivative relationship of documents which are produced in the present embodiment mode;

FIG. 6 is a diagram for representing derivative relationship of documents which are produced in a second comparison example with respect to the embodiment mode of the present invention;

FIG. 7 is a diagram for explaining an operation example of the second comparison example;

FIG. 8 is a diagram for showing one example as to a display screen which is represented as results obtained from a document retrieving operation, an image retrieving operation, and the like in the second comparison example;

FIG. 9 is a diagram as to a second example indicative of derivative relationship of documents which are produced in the present embodiment mode;

FIG. 10 is a diagram for showing one example as to a display screen which is represented as results obtained from a document retrieving operation, an image retrieving operation, and the like in the present embodiment mode; and

FIG. 11 is a diagram (one example of historical information representation screen) for explaining a method of referring to a history of a document based upon the retrieved result screen shown in FIG. 10.

### DETAILED DESCRIPTION

Referring now to drawings, various embodiment modes of the present invention will be described in detail.

### (System Structure)

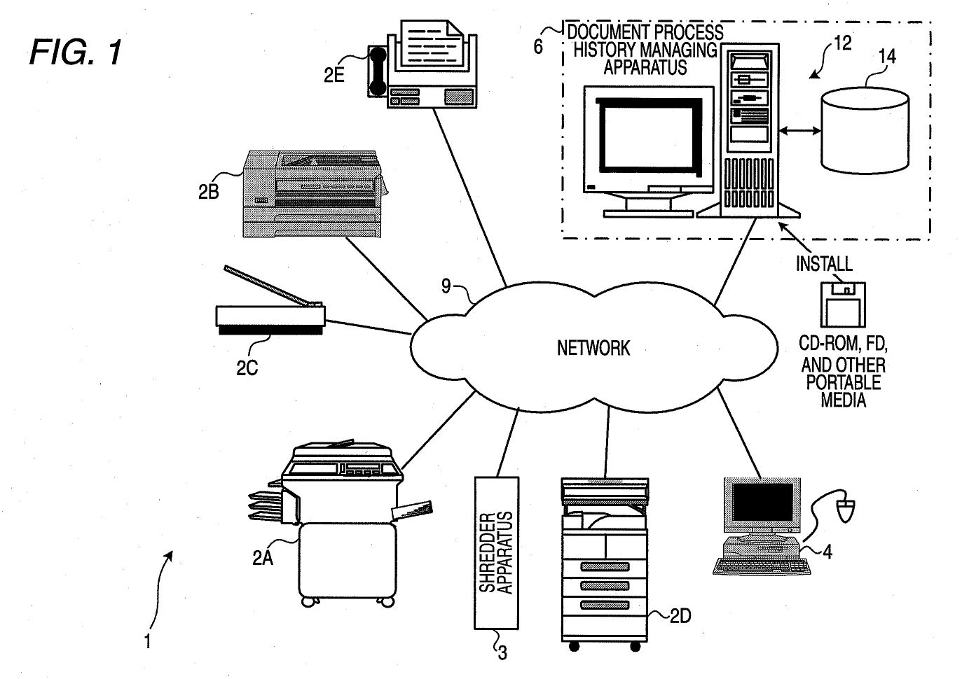

FIG. 1 is a diagram for representing one structural example as to a document process history managing system 1 to which an embodiment mode of the present invention has been applied. As indicated in the drawing, the document process history managing system 1 of the present embodiment mode has been arranged by connecting various sorts of imaging appliances 2, a process instructing apparatus 4, and a document process history managing apparatus 1 to each other via a network 9 corresponding to one example of communication means. The various sorts of imaging appliances 2 have image output functions capable of outputting images on output media such as paper, and also, image acquisition functions capable of reading images formed on output media so as to acquire electronic data of the read images. The process instructing apparatus 4 such as a computer instructs various sorts of imaging appliances 2 to execute image acquiring process operation and image outputting process operation. The document process history managing apparatus 6 has such a server function that processed document images are recorded/saved/managed as process histories (will also be referred to as “logs”) in combination with conditions when the image acquisition process operation and the image output process operation have been performed with respective to the processed document images by the various sorts of imaging appliances 2.

Also, the document process history managing system 1 is equipped with a shredder apparatus 3 used to dispose of a document. While the shredder apparatus 3 is capable of identifying a document when the document is disposed, the shredder apparatus 3 has been connected via the network 9, or the like to the document process history managing apparatus 6, and notifies information about the identified document to the document process history managing apparatus 6.

As these imaging appliances 2, for instance, the below-mentioned appliances are present: a copying machine 2A having both the image acquisition function and the image output function (both functions will be referred to as “duplication function”); a printing apparatus 2B having a single function (only “print function” corresponding to one example of image output function), which is called as a printer; an image reading apparatus 2C having such an image acquisition function called as a scanner (more specifically, will be referred to as “scanner function”), a multi-function machine 2D having the print function, the duplication function, and the scanner function; and further, a facsimile 2E. These imaging appliances 2A, 2B, 2C, 2D, and 2E have been connected via either the network 9 or a predetermined connection interface to the document process history managing apparatus 6. It should be understood that although one set of each sort of these imaging appliances 2 has been illustrated in this drawing, total numbers of the respective imaging appliances 2 may be arbitrarily selected, and/or any of these sorts of imaging appliances may be alternatively omitted.

For instance, while the copying machine 2A has been connected via the network 9 to the document process history managing apparatus 6, when a user operates an operation panel (not shown) of this copying machine 2A so as to instruct a copying operation, the copying machine 2A transmits an image read in response to the copying instruction to the document process history managing apparatus 6. Precisely speaking, this read image implies image data as to electronic data of this read image. At this time, alternatively, the copying machine 2A may cause the user which has issued the copying instruction to enter a user name and/or a password so as to authenticate the user, and then, may transmit information such as a user name which specifies the authenticated user to the document process history managing apparatus 6 in combination with the image.

Furthermore, while the copying machine 2A does not perform an image forming process for directly forming the read image on paper, the copying machine 2A receives the image from the document process history managing apparatus 6, which should be processed in the image forming process, and then, forms a corresponding image on the paper based upon the received image (image data). In other words, the copying machine 2A once transmits an image which has been acquired by reading an original to be copied to the document process history managing apparatus 6, and then, continuously performs a process operation based upon an image (image data) received from the document process history managing apparatus 6.

While the printing apparatus 2B has been connected via the network 9, or the like to the document process history managing apparatus 6, the printing apparatus 2B forms an image on an output medium such as paper based upon an image (image data) entered from the document process history managing apparatus 6.

While the image reading apparatus 2C has been connected via the network 9 to the document process history managing apparatus 6, when the user operates either an operation panel (not shown) of the image reading apparatus 2C or the process instructing apparatus 4 so as to issue a reading instruction, the image reading apparatus 2C transmits an image (image data) read in response to the reading instruction to the document process history managing apparatus 6. At this time, alternatively, the image reading apparatus 2C may cause the user which has issued the reading instruction to enter a user name and/or password so as to authenticate the user, and then, may transmits information such as a user name which specifies the authenticated user to the document process history managing apparatus 6 in combination with the image.

While the multi-function machine 2D has been connected via the network 9 to the document process history managing apparatus 6, the multi-function machine 2D executes the respective functions as to the copying machine 2A, the printing apparatus 2B, and image reading apparatus 2C.

While the facsimile 2E has been connected via the network 9, or the like to the document process history managing apparatus 6, the facsimile 2E transmits a read image in a FAX mode, or outputs a FAX image on an output medium such as paper based upon a received image, and also, outputs processed images when a FAX transmission and a FAX reception are performed to the document process history managing apparatus 6.

While the process instructing apparatus 4 has been connected via the network 9 to the document process history managing apparatus 6, the process instructing apparatus 4 transmits both an image which should be processed by the printing apparatus 2B, the image reading apparatus 2c, and the like, and also, supplementary information such as a name of a user who issues a processing instruction to the document process history managing apparatus 6.

While the document process history managing apparatus 6 is equipped with a server function, in order that the document process history managing apparatus 6 controls an image acquisition process operation and an image output process operation in the imaging appliance 2 in response to a request issued from the process instructing apparatus 4 corresponding to a client system, and also, saves a processed image and relevant information acquired when the image is processed as a process history, the document process history managing apparatus 6 records and saves a feature of a document image in a predetermined storage apparatus. It should also be understood that as to a basic method for acquiring and saving a process history, such a method similar to various sorts of systems known in the technical field may be employed.

The document process history managing apparatus 6 contains a control unit 12, and a data holding unit 14. The data holding unit 14 contains a hard disk apparatus, an optical disk apparatus, or the like as a storage apparatus, which stores thereinto process images and process histories in correspondence with each other. The hardware structure of the control unit 12 may be realized in a similar manner to a general-purpose electronic calculator system which is constituted by employing a CPU (central processing unit) operable as a major unit for performing a control process operation and a calculation process operation; a memory apparatus such as a RAM (Random Access Memory) and a ROM (Read-Only Memory), which stores thereinto process data and program data; and other structural elements. It should be understood that since structural examples as to hardware thereof are well known in the technical field as structures of electronic calculators such as personal computers which are configured from microprocessors for executing software designed for predetermined process operations, the hardware structural examples are omitted in the drawing.

In other words, in the present embodiment mode, the structure of the control unit 12 operable as the central function capable of saving and/or managing information as to operation histories of documents may be constructed of a hardware processing circuit, and furthermore, may be realized in a software manner by employing an electronic calculator (computer) based upon program codes capable of realizing the function of this control unit 12.

As a consequence, either a program or a computer readable storage medium which has stored thereinto the above-described program may be alternatively extracted as the inventive idea of the present invention, while the program is suitably provided in order to realize the system related to the present invention, for saving and/or managing the information as to the operation histories of the documents by employing an electronic calculator (computer) in accordance with software. Since the inventive idea of the present invention may be realized by such a system executed by the software, there is such a merit that processing sequences and the like may be readily changed while the hardware is not changed.

In such a case that the function for saving and/or managing the information as to the operation histories of the documents is executed by an electronic calculator based upon software, a program which constructs the above-described software is installed from a recording medium to a computer (assembled microcomputer etc.) which has been assembled in exclusively-used hardware, an SOC (System On a Chip) capable of realizing a desirable system by mounting such functions as a CPU, a logic circuit and a storage apparatus on a single chip, or a general-purpose personal computer capable of executing various sorts of functions by installing various sorts of programs.

The above-described recording medium corresponds to such a recording medium whose contents described in a program can be transferred to a reading apparatus provided in a hardware resource of a computer in such a manner that status changes of energy such as magnetic energy, optical energy, and electronic energy are conducted in response to the contents described in the program, and these status changes can be transferred with respect to the reading apparatus in signal formats corresponding thereto. For example, the above-explained recording medium may be constituted by magnetic disks (involving flexible disk FD), optical disks (involving CD-ROM (compact Disk-Read Only Memory), DVD (Digital Versatile Disk) etc.), or Magnetic Optical disks (involving MO (Magnet Optical disk), on which programs distributed so as to be provided with respect to users have been recorded in a separated manner with respect to a computer. Alternatively, the above-described recording medium may be constructed by utilizing ROMs, harddisks, or the like, which are constituted not only by package media (portable storage media) made of semiconductor memories etc., but also which are provided to users under such a condition that programs have been previously installed in a computer. Moreover, the program which constitutes the software is not limited only to be provided via such recording media, but also may be provided via a wireless communication network, or a wired communication network.

The control unit 12 receives both an image which should be processed and supplementary information from the imaging appliance 2 such as the copying machine 2A, or the printing apparatus 2B, and then, stored the image of the document and the supplementary information (for example, document ID, version, attribute etc.) into the data holding unit 14 as process history information. The above-described supplementary information (namely, information other than image for specifying a condition of process operation) implies such information capable of specifying information about a process operations, for example, process conditions such as a user name who has requested to process the image, and process day/time. Also, the control unit 12 transmits the image which has been received as the processing subject to the imaging appliance 2 such as the copying machine 2A, or the printing apparatus 2B, or otherwise the facsimile 2E so as to execute an image processing operation. Moreover, upon receipt of a retrieving instruction as to process history information, the control unit 12 executes a retrieving process operation by which the control unit 12 retrieves the process history information stored in the data holding unit 14, and then, provides a result of this retrieving operation.

To execute the above-described retrieving process operation, when an image is processed by the imaging appliance 2, such an information (identifier ID) for exclusively specifying the image and a version “VO” have been previously embedded into an output medium (any sorts of outputting methods, for example, image is outputted to paper medium, file of electronic data is saved, etc.) by utilizing various sorts of means, for instance, a bar code, an IC tag, and an electronic watermark. When the processed image is again processed in the imaging appliance 2, the ID and the version of this processed image are read. Then, a document image “G1” which has been previously saved in the data holding unit 14 and is specified based upon the read information is compared with a document image “G2” read out from the output medium.

In such a case that there is a difference between the document image “G1” and the document image “G2”, it is so assumed that a certain editing process (namely, content of document has been changed) has been carried out with respect to the existing document image “G1” held in the data holding unit 14. Thus, the control unit 12 applies a new version “VE” and causes the document image “G2” to be related to this applied version “VE.” If an operation performed in the imaging appliance 2 is directed to perform a duplicating operation of a document without the editing process (correction), then the control unit 12 applies a new version “VC” to the duplicated document, assuming now that the image has been derived. When there is such a difference between the document image “G1” and the document image “G2”, since the new version “VE” is applied with respect to the document image “G2”, the above-described new version “VC” may be derived from a version “VN” thereof. If not, then this new version “VC” may be derived from the original version “VO” of the document image “G1” held in the data holding unit 14.

### Structural Example of Document Process History Managing Apparatus

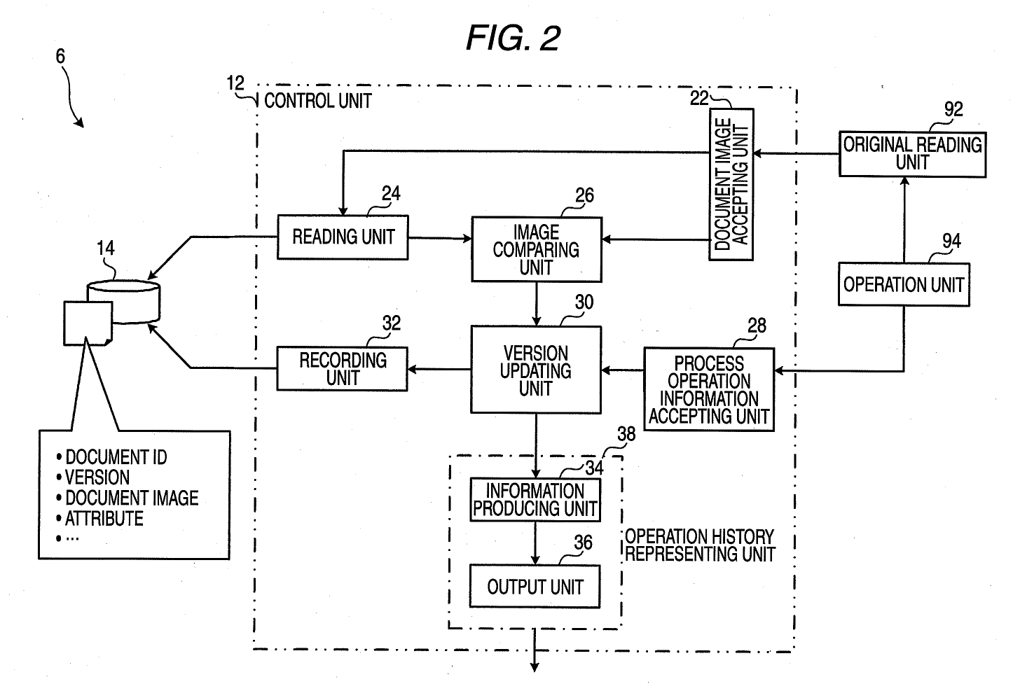

FIG. 2 is a diagram for showing a structural example of the document process history managing apparatus 6. Precisely speaking, as the system for performing the above-described process operation, the control unit 12 contains a document image accepting unit 22 as a function block. The document image accepting unit 22 accepts a processed image from an original reading unit 92 mounted on, for example, the copying machine 2A, the image reading apparatus 2C, the multi-function machine 2D, or the like.

It should also be noted that the user sets (puts) an original image “P1” at a predetermined position of the original reading unit 92, and performs an operation input “O1” such as a copying operation, a facsimile transmission, a scanning operation, and a deletion in a shredder via an operation unit 94 (otherwise, process instructing apparatus 4) such as an operation panel mounted on the imaging appliance 2. The original reading unit 92 reads an image (especially, referred to as “input image”) “I IN” a document (original), document identification information “(ID) D1” for exclusively specifying the document, and version information “V1” for specifying a version from the original image “P1.”

The control unit 12 also contains a reading unit 24, an image comparing unit 26, and a process operation information accepting unit 28. The reading unit 24 reads out the latest version “V2” which is not the duplication of the version information “V1”, and an image (especially, referred to as “saved image”) “I REC” which has been related to the latest version “V2” from the information saved in the data holding unit 14. The image comparing unit 26 compares the input image “I IN” with the saved image “I REC” read out from the reading unit 24 so as to calculate differential information “Diff (I IN, I REC)” between these images. The process operation information accepting unit 28 accepts information about the process operation with respect to the document from the operation means such as the operation panel mounted on the imaging appliance 2.

Also, the control unit 12 contains a version updating unit 30, a recording unit 32, an information producing unit 34, and an output unit 36. The version updating unit 30 constitutes one example of a version information applying unit for producing new version information (either zero piece or plural pieces of version information) based upon both the operation input O1 and the differential information “Diff (I IN, I REC)”. In the case that one, or more pieces of the version information “VN” are present, the recording unit 32 records, one, or more pieces of versions Ver, (D1, VN, I, IN)” of document identification information D1 in the data holding unit 14. The information producing unit 34 produces the output information based upon the input image “I IN, ” the document identification information D1, and the version information VN. The output unit 36 outputs the output information produced by the information producing unit 34 to such an output destination as paper, an electronic mail, an electronic file, a facsimile line, or the like. An operation history producing unit 38 is constituted by the information producing unit 34 and the output unit 36. While a retrieving instruction is accepted as a condition, the above-described operation history providing unit 38 produces information as to operation histories of respective documents which have a derivative relationship with a document which should be retrieved, and then, provides the produced information as to the operation histories of the respective documents.

As the output information produced by the information producing unit 34, for example, there are: an image “I OUT” corresponding to the input image “I IN”; character information corresponding to the document identification information D1 for specifying the document; character information corresponding to the version information VN; and the like.

### (Summarized Process Operation of Version Updating Unit)

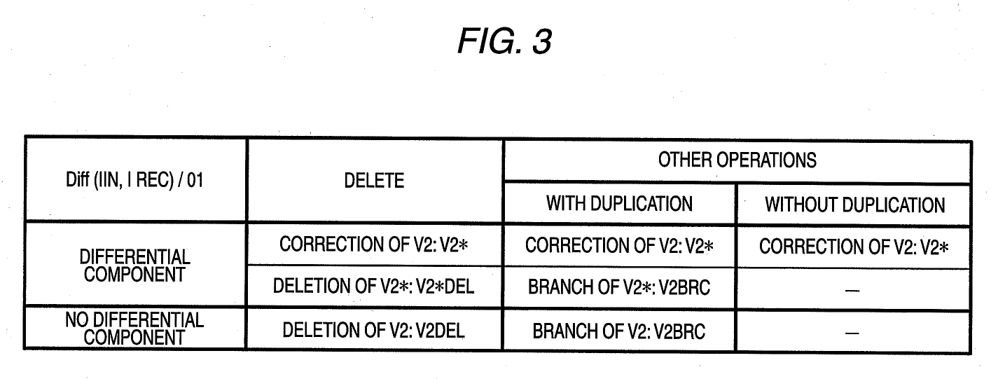

FIG. 3 is a diagram for explaining a summary of a major processing operation executed in the version updating unit 30, and more specifically, is a diagram for representing a relationship of information which is produced based upon the operation input “O1” and the differential information “Diff (I IN, I REC)” by the version updating unit 30. While the version updating unit 30 basically produces zero pieces, or plural pieces of new version information “VN”, as shown in FIG. 3, positionings of the numbers of the produced version information “VN” as versions are different from each other based upon the operation input O1 and the differential information “Diff (I IN, I RE).”

For instance, in such a case that there is a difference (namely, editing operation for document), when a deleting/discarding instruction is issued to the latest version V2, the control unit 12 applies correction version “V2*” indicative of derivative relationship of a document in order to indicate the deletion of the latest version V2. At this time, as another operation, in any one of such a case that a duplicating operation is performed in combination therewith, and another case that the duplicating operation is not performed (namely, irrespective of such a case whether or not duplicating operation is required), the control unit 12 similarly corrects the latest version V2, and then, applies the correction version “V2*” indicative of the derivative relationship of the document.

In such a case that there is a difference, when a deleting (discarding) instruction is issued to the correction version “V2*”, the control unit 12 applies a correction deleting version “V2*DEL” indicative of derivative relationship of a document in order to indicate the deletion of the correction version “V2*.” At this time, in any one of such a case that a duplicating operation is performed in combination therewith, and another case that the duplicating operation is not performed (namely, irrespective of such a case whether or not duplicating operation is required), the control unit 12 corrects the latest version V2, and then, applies the correction version “V2*” indicative of the derivative relationship of the document. At this time, as another operation, in the case that a duplicating operation of the correction version “V2*” is performed in combination therewith, the control unit 12 applies a branch version “V2BRC” indicative of derivative relationship of a document in order to represent that the correction version “V2*” has been branched.

In such a case that there is no difference, when a deleting instruction is issued to the latest version V2, the control unit 12 applies a deletion version “V2DEL” indicative of derivative relationship of a document in order to indicate the deletion of the latest version “V2.” AT this time, in the case that a duplicating operation is performed in combination therewith, the control unit 12 applies a branch version “V2BRC” indicative of derivative relationship of a document in order to represent that the correction version “V2*” has been branched.

### Derivative Relationship of Documents

### FIRST EXAMPLE

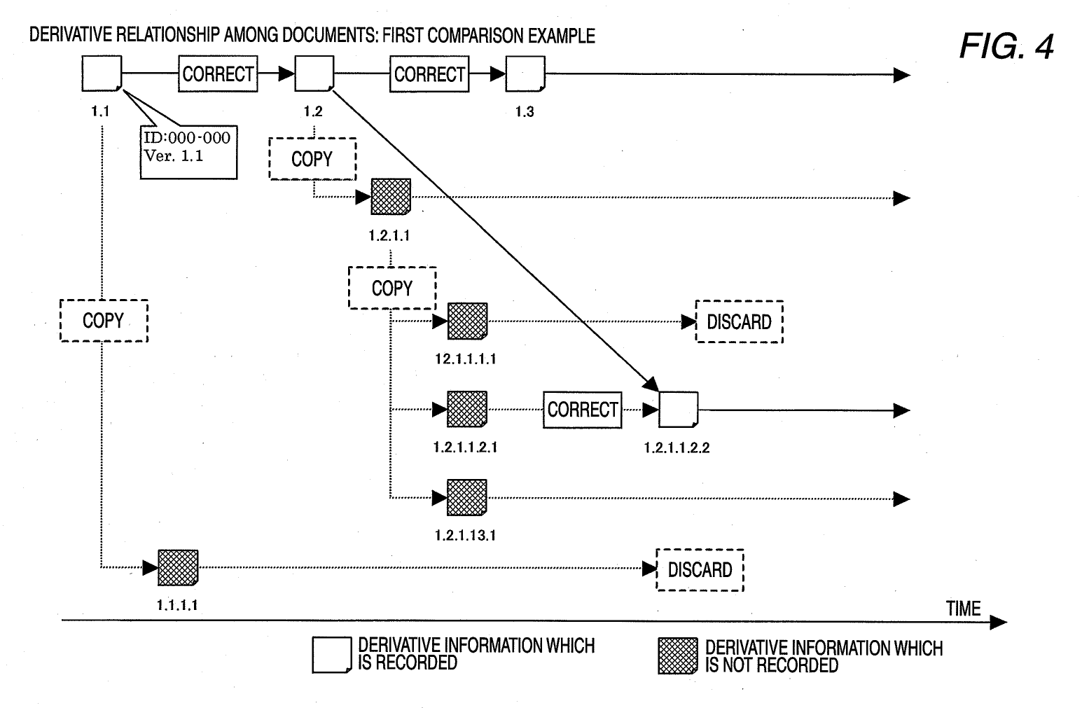

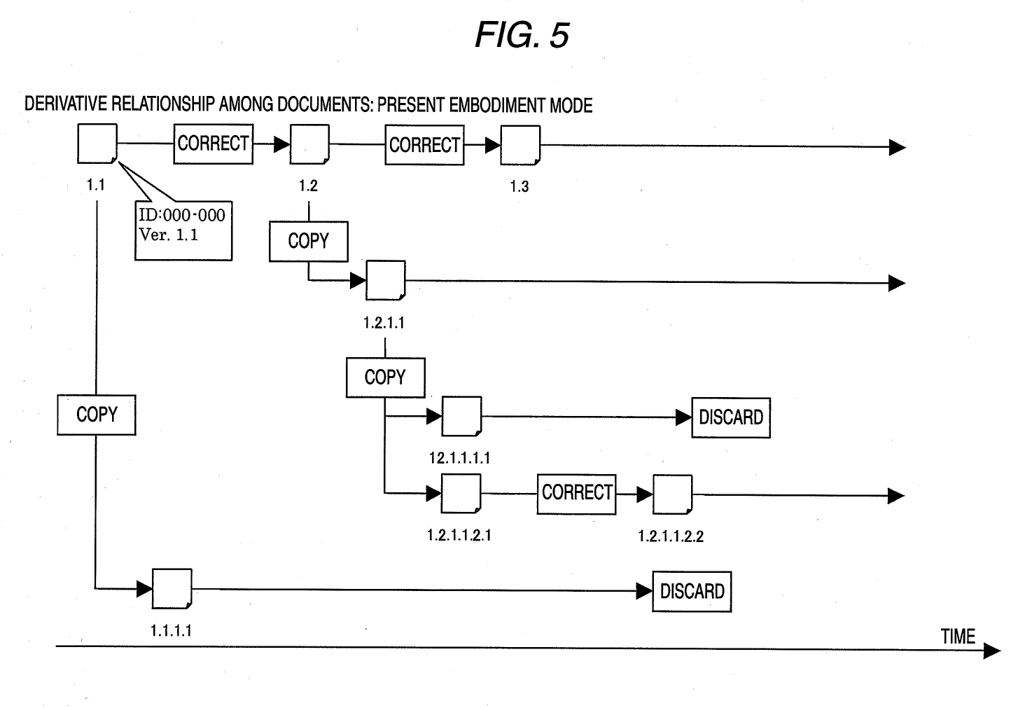

FIG. 4 and FIG. 5 are diagrams of a first example for describing a feature as to such a derivative relationship among documents which are produced under control of the document process history managing apparatus 6 according to the present embodiment mode. In this case, FIG. 4 is a diagram for representing a first comparison example with respect to the present embodiment mode, namely, corresponds to a diagram for showing the derivative relationship of the documents produced by the version management in the system disclosed in JP-A-11-327980. FIG. 5 is a diagram of a first example for representing derivative relationship of documents which are produced under control of the document process history managing apparatus 6 according to the present embodiment mode.

In the case of the first comparison example, as indicated in FIG. 4, as to derivative relationship of information which is recorded in accordance with the version managing method thereof, it is an object to record only the content of this derivative relationship. As a result, there is no chance to record such a derivative relationship without performing an editing operation (correction) with respect to a document which should be processed, for instance, copying operations of documents (indicated by dot line in FIG. 4) and scanning operations of documents (refer to documents hatched in FIG. 4). As a consequence, there are some possibilities that no one can grasp such an event that how many documents have been derived, and how a document has been derived by which user.

On the other hand, in the case of the present embodiment mode, as indicated in FIG. 5, derivative relations of information which is recorded by the version managing method thereof are recorded in the below-mentioned two cases: That is, a derivative relations without performing an editing operation (correction) with respect to a document which should be processed, for example, copying operations of documents and scanning operation of documents is recorded. Also, documents are disposed (deleted) by shredder apparatus capable of identifying a document when the document data is discarded. In comparison with recording of the derivative relationship based upon the first comparison example, derivative versions are recorded with respect not only to the contents of the documents, but also the quantities of the output media. In other words, the “derivative” relationship and the “continuous” relationship are managed in a separate manner based upon the operations performed with respect to the documents irrespective of a total number of the relevant versions.

### Derivative Relationship of Documents

### SECOND EXAMPLE

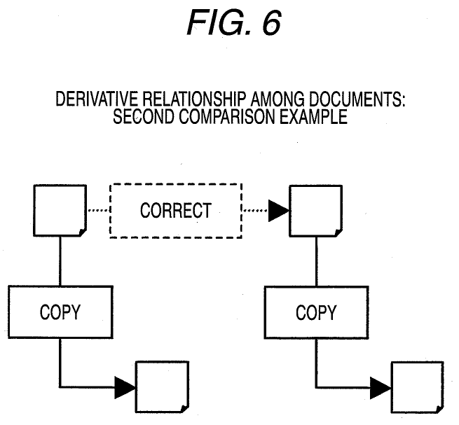

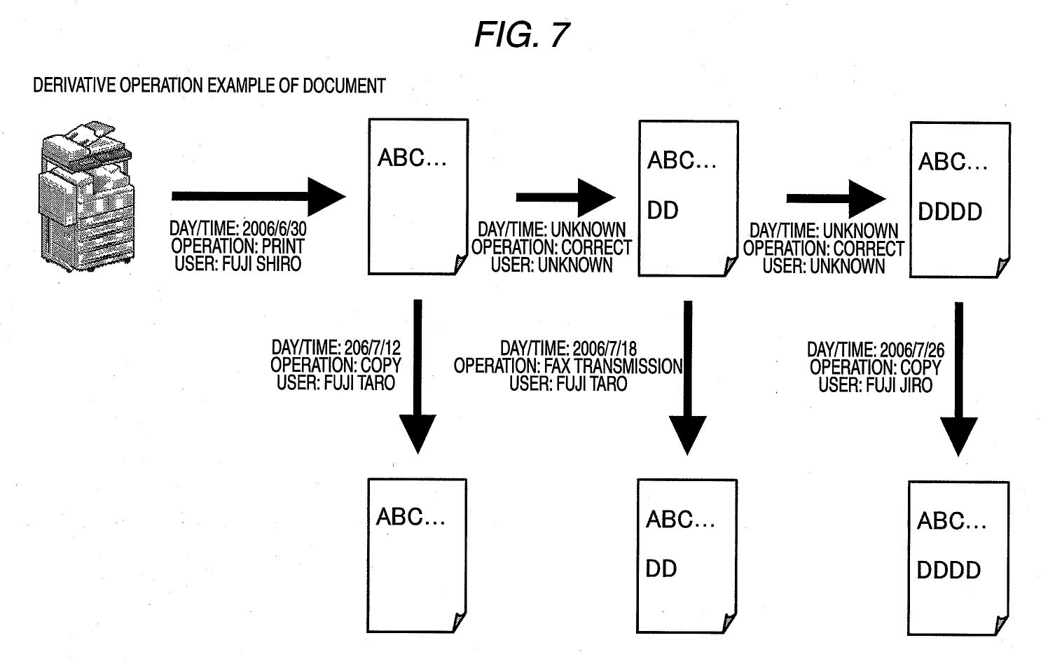

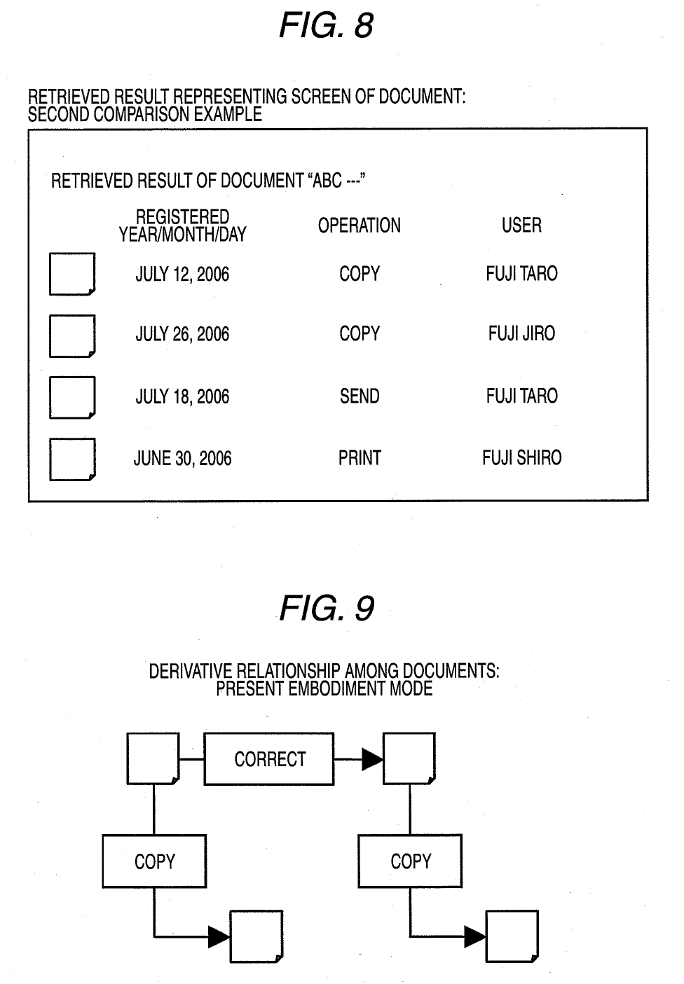

FIG. 6 to FIG. 11 are diagrams of a second example for describing a feature as to such a derivative relationship among documents which are produced under control of the document process history managing apparatus 6 according to the present embodiment mode. In this case, FIG. 6 is a diagram for representing a second comparison example with respect to the present embodiment mode, namely, corresponds to a diagram for showing the derivative relationship of the documents produced by the image process history management employed in the system disclosed in JP-A-2007-172233. FIG. 7 is a diagram for explaining an operation example of the second comparison example. FIG. 8 is a diagram for showing an example as to a display screen which is represented as results such as a document retrieved result and an image retrieved result obtained in the second comparison example.

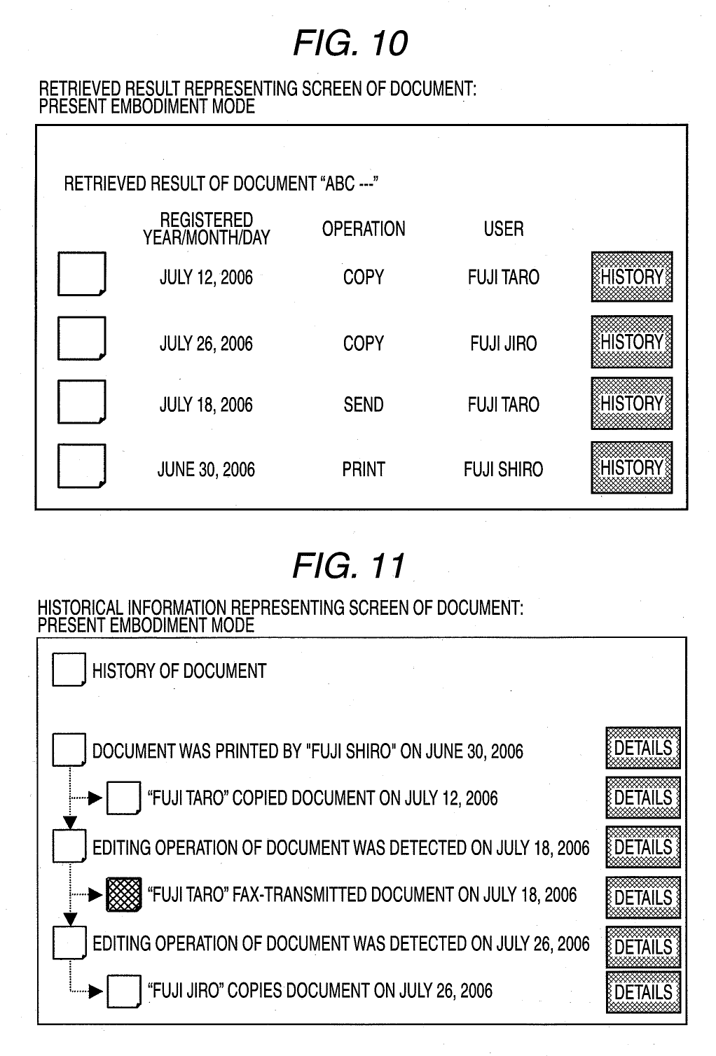

FIG. 9 is a diagram of a second example for representing derivative relationship among documents which are produced under control of the document process history managing apparatus 6 according to the present embodiment mode. FIG. 10 is a diagram for showing an example as to a display screen which is represented as results such as a document retrieved result and an image retrieved result obtained in the present embodiment mode. FIG. 11 is a diagram for explaining a method of referring to a history of a document based upon the retrieved result screen shown in FIG. 10 (namely, one example as to historical information representing screen).

In the case of the second comparison example, as shown in FIG. 6, with respect to the derivative relationship of the information recorded based upon the version managing method, resembling documents are grouped and then a typical document among the grouped documents is represented so as to improve the utility during the retrieving operation. As a result, when a correction is made in a document, since relationship between the document and the corrected document is not recorded, a derivative relationship including the change in the contents is not recorded. In other words, this version managing method has such a purpose that the documents are grouped which may be seen as resembling documents. As a result, there is no chance for recording and managing the changes in the document contents. In FIG. 6, in order to represent the above-described technical idea, a portion for a correcting operation has been indicated by a dot line.

For example, a concrete operation example as to the second comparison example is indicated in FIG. 7. In this concrete operation example, the following case is considered: Such a document described by way of “ABC - - - ” has been derived in the bellow-mentioned manner. Firstly, a printing process operation has been carried out in response to an instruction issued from a user “Fuji Shiro” on “2006/6/30”; a copying (duplicating) process operation has been carried out in response to an instruction issued from a user “Fuji Taro” on “2006/7/12”; and although both a day/time (at least such a date before “2006/7/18”) and a user name are not known, a correction has been added with respect to the above-described document.

Then, with respect to this document to which the correction has already been added, a FAX transmitting process operation is carried out in response to the user “Fuji Taro” on “2006/7/18”; and further, although both a day/time (at least such a date before 2006/7/26) and a user name are not known, a correction has been added with respect to the above-described document. Then, with respect to the document to which the correction has additionally added, a copying (duplicating) process operation has been carried out in response to an instruction issued from a user “Fuji Jiro” on “2006/7/26.”

In this case, the following assumption is made: That is, it is revealed that a document described by way of “ABC - - - DD” flowed out as a FAX on “2006/7/18.” At this time, when information about this outflow document is tried to be specified by employing an imaging log management server (namely, corresponding to document process history managing apparatus 6 of present embodiment mode), such a retrieve result screen as indicated in FIG. 8 is displayed as a result obtained by a document retrieving operation, an image retrieving operation, and the like. As a result, information indicated in an item 1) related to the outflow document can be specified, and furthermore, information about 2 persons indicated in items 2) and 3), who handled documents having resembling contents (resembled documents) can also be specified. However, based upon the information about the retrieved results which can be specified by the system of the second comparison example, no one can recognize whether or not these two persons had some relationship with the outflow of this information.

1) The document flowed by the user “Fuji Taro” on “2006/7/18.”

2) The document was printed by the user “Fuji Shiro” on “2006/6/30.”

3) The document was copied by the user “Fuji Jiro” on “2006/7/26.”

On the other hand, in the case of the present embodiment mode, with respect to the derivative relationship of the information recorded based upon the version managing method thereof, as shown in FIG. 9 (refer also to FIG. 5), as also to the document to which the correction has been added, the derivative relationship thereof is recorded. In comparison with FIG. 6, in FIG. 9, in order to indicate the above-described inventive idea, a portion of a correcting operation has been represented by a solid line.

Under similar operation condition to that of such a case as to the operation example of the second comparison example shown in FIG. 7, when it can be revealed that the document described by way of “ABC - - - DD” flowed out as the FAX on “2006/7/18”, if the information about this outflow document is tried to be specified by employing the document process history managing apparatus 6 of present embodiment mode, which has the image log management server function, first of all, then such a retrieved result screen as indicated in FIG. 10 is displayed as a result obtained by a document retrieving operation, an image retrieving operation, and the like. In comparison with the second comparison example indicated in FIG. 8, the below-mentioned featured points are present: That is, a “history button” has been added to each of the documents extracted in the retrieving operation.

Now, if the “history bottom” as to the document written by way of “ABC - - - DD” flowed out as the FAX is clicked, then operation histories about all of the documents related to such a document flowed as the FAX on “2006/7/18” are displayed, as shown in FIG. 11. These documents imply all of such documents having such a derivative relationship with the relevant document flowed out as the FAX, which is shown by a hatched line in FIG. 11.

As a result, in addition to the information described in the above-described items 1) to 3) represented in the second comparison example, such information as described in the below-mentioned items 4) to 7) is represented while the document written by way of “ABC - - - DD” flowed out as the FAX is defined as a key, when the operation histories of the respective documents having the derivative relationship therewith are represented substantially immediately and without any omission. The information as to these items 4) to 7) is related to such a fact that what operation has been performed by some persons who have a certain relation with the outflow of the information. When the information as to the operation histories of the respective documents is represent which have the derivative relationship with respect to the document to be retrieved, both an instantaneous characteristic and an all-exclusive characteristic can be secured.

4) The outflow document has been originated from such a document printed by the user “Fuji Shiro.”

5) The outflow document has been transferred from the user “Fuji Shiro” to the user “Fuji Taro” based upon a certain method.

6) The user “Fuji Taro” has held a copy of the outflow information.

7) The outflow document has been transferred from the user “Fuji Taro” to the user “Fuji Jiro” based upon a certain method.

In the systematic ideas of the first comparison example and the second comparison example, with respect to the targets such as the measures for the information leakage and either securing or the internal control of the enterprise compliance, for instance, no one can grasp that which users have formed documents and which users have transferred the formed documents. As a result, only such an individual person is merely specified who has been finally concerned with the information leakage, but such information is not represented so as to grasp a problem such as a process related to forming and transferring of the documents. Also, even when there is another document (namely, document having derivative relationship) having the same origin as that of such a document having a problem of information leakage, no one can become aware of this document. Accordingly, such information is not represented by which any user can grasp that the same problem has occurred, or may probably occur. As a result, haphazard measures will be taken from start to end.

On the other hand, in the systematic idea of the present embodiment mode, as apparent from the foregoing descriptions, not only such an information capable of specifying the individual person who has been finally concerned with the information leakage is represented, but also another information is represented which is capable of grasping the problem such as the process related to forming and transferring of the documents. In such a case that there is another document having the same origin as that of such a document having the problem of the information leakage, the information about the operation histories of other documents having the derivative relationship thereof is represented without any omission.

While the present invention has been described with reference to the above-described embodiment modes, the technical scope of the present invention is not limited only to the technical scope of the above-described embodiment modes. The inventive ideas of the above-described embodiment mode may be modified, or changed without departing from the gist of the present invention. Accordingly, the modified, or changed embodiment modes may be apparently covered within the technical scope of the present invention.

Also, it should be understood that the above-described embodiment mode never restricts the inventive ideas of the present invention described in Claims, and furthermore, all of combinations as to the features described in the embodiment modes are not necessarily required in the solving means of the present invention. Since various stages of the inventive ideas of the present invention have been included in the above-described embodiment modes, various sorts of inventive ideas may be extracted by properly combining a plurality of disclosed structural elements with each other. Even when several structural elements are deleted from all of the structural elements described in the embodiment modes, such an arrangement from which these several structural elements have been deleted may be extracted as the present invention as long as the effects thereof may be achieved.

For example, in the concrete examples in the above-described embodiment mode, the following events have been described: That is, the image of the document is duplicated, printed, and transmitted in the FAX mode, namely, the image of the document is mainly outputted to the paper media. The process operations executed based upon the document to be processed are not limited only to the above-described concrete example. Alternatively, another process operation may be employed which handles only electronic data in a pure electronic manner. Even when the purely electronic process operation is carried out, since output process operations for forming and editing documents as electronic files are necessarily carried out, the systematic idea of the above-described embodiment mode may be similarly applied as such a systematic idea capable of managing histories of these operations without any omission.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A document process history managing system comprising:
a storage apparatus that stores information; and
a document process history managing apparatus that is operated in such a manner that, in a case where a process operation is carried out on a document by employing an image processing apparatus, historical information of the process operation is saved in the storage apparatus in combination with the image of the document,
the document process history managing apparatus including:
a process operation information accepting unit that accepts information about the process operation with respect to a document to be processed;
a version information applying unit that applies version information indicating derivative relationship based upon a document before the process operation is carried out in correspondence with the document to be processed, every time the process operation is carried out, based upon the information of the process operation accepted by the process operation information accepting unit regardless of such a fact as to whether or not an editing operation is performed, and whether or not a copying operation is performed with respect to the document;
a recording unit that stores an image indicating a document which includes a processed result obtained based upon the document to be processed, the information about the operation history, and the version information applied by the version information applying unit into the storage apparatus in correspondence with each other; and
an operation history representing unit that produces information about operation histories of respective documents having a derivative relationship with the document to be retrieved in a condition that a retrieving instruction is accepted, and represents the produced operation history information.

2. A document process history managing apparatus comprising:
a process operation information accepting unit that accepts information about the process operation with respect to a document to be processed;
a version information applying unit that applies version information indicating derivative relationship based upon a document before the process operation is carried out in correspondence with the document to be processed, every time the process operation is carried out, based upon the information of the process operation accepted by the process operation information accepting unit regardless of such a fact as to whether or not an editing operation is performed, and whether or not a copying operation is performed with respect to the document;
a recording unit that stores an image indicating a document which includes a processed result obtained based upon the document to be processed, the information about the operation history, and the version information applied by the version information applying unit into an external storage apparatus; and
an operation history representing unit that produces information about operation histories of respective documents having a derivative relationship with the document to be retrieved in a condition that a retrieving instruction is accepted, and represents the produced operation history information.

3. The document process history managing apparatus as claimed in claim 2, further comprising:
a document image accepting unit that accepts an image of the document to be processed;
a reading unit that reads an image corresponding to the image of the document to be processed accepted by the document image accepting unit from the images of the documents stored in the storage apparatus; and
an image comprising unit that compares the image read by the reading unit with the image of the document to be processed, which is accepted by the document image accepting unit,
wherein
the version information applying unit determines whether or not a process operation is performed in combination with an editing operation with respect to a document based upon a comparison result obtained by the comparing unit.

4. A document process history managing method comprising:
accepting information about the process operation with respect to a document to be processed;
applying version information indicating derivative relationship based upon a document before the process operation is carried out in correspondence with the document to be processed, every time the process operation is carried out, based upon the information of the process operation accepted in the accepting of the information regardless of such a fact as to whether or not an editing operation is performed, and whether or not a copying operation is performed with respect to a document;
storing an image indicating a document which includes a processed result obtained based upon the document to be processed, the information about the operation history, and the version information in correspondence with each other; and
producing information about operation histories of respective documents having a derivative relationship with the document to be retrieved in a condition that a retrieving instruction is accepted, and representing the produced operation history information.

5. A computer readable medium storing a program causing a computer to execute a process for saving and managing information about an operation history of a document, the process comprising:
accepting information about the process operation with respect to a document to be processed;
applying version information indicating derivative relationship based upon a document before the process operation is carried out in correspondence with the document to be processed, every time the process operation is carried out, based upon the information of the process operation accepted in the accepting of the information regardless of such a fact as to whether or not an editing operation is performed, and whether or not a copying operation is performed with respect to a document;
storing an image indicating a document which includes a processed result obtained based upon the document to be processed, the information about the operation history, and the version information in correspondence with each other; and
producing information about operation histories of respective documents having a derivative relationship with the document to be retrieved in a condition that a retrieving instruction is accepted, and representing the produced operation history information.
